(19) United States
(12) Patent Application Publication
(10) Pub. No.: US 2006/0060291 A1
(43) Pub. Date: Mar. 23, 2006

(54) Hydraulic decalcomania transfering apparatus and residue discharging mechanism used therefor

(75) Inventors: Masato Yamamori, Aichi (JP); Tatsuki Ochiai, Aichi (JP)

Correspondence Address: GREENBLUM & BERNSTEIN, P.L.C., 1950 ROLAND CLARKE PLACE, RESTON, VA, 20191, US

(73) Assignee: Trinity Industrial Corporation, Aichi (JP)

(21) Appl. No.: 11/230,513

(22) Filed: Sep. 21, 2005

(30) Foreign Application Priority Data
Sep. 21, 2004 (JP) 2004-273820

(51) Int. Cl. B44C 1/165; B65H 37/00

(52) U.S. Cl. 156/230; 156/540

(57) ABSTRACT

A hydraulic decalcomania transferring apparatus having residue discharging mechanism in which a vacuum chamber for sucking residues of a decalcomania transferring film floating on the water surface in a decalcomania transferring tank through a pipe from a sucking port is disposed to the outside of the tank, and the vacuum chamber has a discharge port for discharging the residues and water sucked in the chamber, and a drain valve for opening and closing the discharge port, whereby the residues of the decalcomania transferring film can be discharged rapidly in a short time to the outside of the tank and deposition of the residues to the surface of a work to possibly cause seediness can be prevented reliably.

### BACKGROUND OF THE INVENTION

1. Field of the Invention

The present invention concerns a hydraulic decalcomania transferring apparatus for urging a work to be applied with decalcomania transfer onto a hydraulic decalcomania transferring film supplied to the water surface in a hydraulic decalcomania transferring tank thereby submerging the work and, more in particular, it relates to a hydraulic decalcomania transferring apparatus having a residue discharging mechanism for discharging residues of the decalcomania transferring film floating on the water surface in the hydraulic decalcomania transferring tank to the outside of the tank, as well as a residue discharging mechanism used therefor.

2. Statement of Related Art

Generally, a water soluble film once used as a medium for decalcomania transfer and becomes no more necessary is removed by water washing from a work to be applied with decalcomania transfer (hereinafter referred to as a work), water deposited on the surface of the work was dried and, as a final finishing, a top coat is applied as clear coating for surface protection. However, for works having various three dimensional shapes such as interior parts or exterior parts of automobiles, clear coating of applying uniform surface protective coating entirely required highly skilled technique and complicate control for the coating apparatus that automatically conduct the coating operation, so that the fabrication cost and the installation cost for applying the top coat were expensive.

In view of the above, a hydraulic decalcomania transferring film (hereinafter also referred to as a decalcomania transferring film) capable of applying a uniform surface protective coating to the work by a simple and convenient means without requiring highly skilled technique or complicate control has been proposed (refer to JP-A No. 2003-200698). The proposed decalcomania transferring film comprises a multi-layered film in which a water insoluble curable resin layer to be cured by irradiation of actinic energy rays such as ultraviolet rays or by heating to form a surface protective coating is formed between a water soluble film and a printed layer formed on one surface thereof. After hydraulically decalcomania transferring the printed layer of the film together with the curable resin layer to the surface of a work to be transfer, a uniform surface protective coating can be applied to the surface of the work merely by a simple processing of irradiating UV-rays in a case where the curable resin layer is formed from a UV-ray curable resin and by heating to a curing temperature in a case where the curable resin layer is formed from a thermosetting resin.

However, in a case of using the decalcomania transferring film described above, a surplus portion of the film not transferred to the work remains as residues on the water surface of the hydraulic decalcomania transferring tank (hereinafter also referred to as a decalcomania transferring tank). Since the film residues mainly comprise a water insoluble resin film of a low specific gravity as a constituent of the curable resin layer, the residues floating on the water surface in the decalcomania transferring tank and deposited to a work going out of the decalcomania transferring tank or to a subsequent work coming into the decalcomania transferring tank to possibly cause coating failure such as seediness on the surface thereof.

Therefore, it was adapted to always circulate water in the decalcomania transferring tank so as to generate a surface stream flowing in one direction at such a flow rate as not creasing the decalcomania transferring film to the water surface in the decalcomania transferring tank to which the film is supplied thereby flushing away the residues floating on the water surface by the surface stream (for example refer to JP-A No. 2003-261122). However, since it is difficult to remove the film residues floating on the water surface in the decalcomania transferring tank efficiently in a short time only by such means, in a case where the production tact for the decalcomania transfer is promoted to improve the productivity, residues of the film not transferred to a preceding work may possibly be deposited to the surface of a succeeding work to cause seediness on the surface thereof.

In view of the foregoings, in order to prevent deposition of the residues of the decalcomania transferring film left on the water surface of the decalcomania transferring tank to the surface of the work which would cause seediness on the surface thereof, the present inventors have developed a hydraulic decalcomania transferring apparatus (hereinafter referred to as a decalcomania transferring apparatus) provided with a pair of gates each having a suction mechanism for sucking the residues of a decalcomania transferring film floating on the water surface in a decalcomania transferring tank that suck the residues of the decalcomania transferring film floating on the water surface from both the inlet side and the exit side of the decalcomania transferring tank to and from which a work enters and exits while the work that abuts against and urges the decalcomania transferring film downward is being submerged in the tank.

The gate having the suction mechanism provided to the decalcomania transferring apparatus is adopted to suck the residues of the decalcomania transferring film floating on the water surface in the decalcomania transferring tank together with water in the tank from the suction port that opens slitwise along the lateral direction of the decalcomania transferring tank and discharge them through the suction hose connected with the suction port to the outside of the decalcomania transferring tank. However, in the decalcomania transferring film in which a water insoluble curable resin layer is formed between the water soluble film and the printed layer as described above, since the surplus curable resin layer not transferred to the surface of the work flows as the residues of the thin resin film on the water surface in the decalcomania transferring tank and the resin film is water insoluble and less disintegrating, in a case where the size of the decalcomania transferring film and, thus, the residues of the resin film is large, it is difficult to rapidly suck all the resin film through the suction port and discharge the same out of the tank entirely during submersion of the work in the decalcomania transferring tank.

### SUMMERY OF THE INVENTION

The present invention intends to rapidly discharge the residues of the decalcomania transferring film to the outside of a decalcomania transferring tank thereby capable of reliably preventing the residues from depositing on the surface of the work and causing seediness even in a case where a water insoluble curable resin layer is formed between the water soluble film and the printed layer of the decalcomania transferring film to be used or in a case where the size of the film to be used is large.

The present invention provides, in a first aspect, a hydraulic decalcomania transferring apparatus having a residue discharging mechanism for discharging residues of a decalcomania transferring film floating on a water surface in a decalcomania transferring tank to the outside of the tank in which a vacuum chamber for vacuum-sucking the residues of the decalcomania transferring film floating on the water surface in the decalcomania transferring tank together with water in the tank through a pipe connected with a suction port for sucking the residues together with water is provided and; the vacuum chamber is provided with a discharge port for discharging the residues and water sucked in the chamber and a drain valve for opening and closing the discharge port.

In the decalcomania transferring apparatus according to the invention, the discharge port of the vacuum chamber is closed by the drain valve to evacuate the inside of the chamber, residues of the decalcomania transferring film floating on the water surface in the decalcomania transferring tank are rapidly sucked together with water in the decalcomania transferring tank from the suction port and then sucked under vacuum into the vacuum chamber by way of the pipe connected with the suction port. Then, when the drain valve is opened to open the discharge port for the vacuum chamber, the residues of the decalcomania transferring film and water sucked into the vacuum chamber are discharged from the discharge port.

Further, the invention provides, in another aspect, a residue discharging mechanism for discharging residues of a decalcomania transferring film floating on a water surface in a decalcomania transferring tank to the outside of the tank, in which a vacuum chamber for sucking under vacuum the residues together with water in the decalcomania transferring tank has a discharge port for discharging the residues and water sucked in the chamber and a drain valve for opening and closing the discharge port, and the drain valve is adapted to close by the suction force of the vacuum pump for evacuating the inside of the vacuum chamber and open when the suction force of the vacuum pump can no more resist the weight of the residues and water sucked in the vacuum chamber by the weight thereof.

In the residue discharging mechanism of the invention, the drain valve is closed when the inside of the vacuum chamber is evacuated by the suction force of a vacuum pump and the discharge port of the vacuum chamber is closed by the drain valve, and the residues and water are sucked under vacuum into the chamber. Then, when the suction force of the vacuum pump is lowered to such an extend as can no more resist the weight of the residues and water sucked in the vacuum chamber, the drain valve is opened due to the weight of the residues and water to open the discharge port of the vacuum chamber, and the residues and water in the vacuum chamber are discharged through the discharge port.

According to the invention, since the residues of the decalcomania transferring film floating on the water surface in the decalcomania transferring tank are sucked under vacuum by the vacuum chamber, even in a case where the decalcomania transferring film comprises, for example, a water soluble film and a printed layer, and a water insoluble curable resin layer formed therebetween, or even in a case where the size of the film to be used is large, the residues of the film can be discharged rapidly to the outside of the decalcomania transferring tank and deposition of the residues to the surface of the work which would otherwise cause seediness can be prevented reliably.

### PREFERRED EMBODIMENT OF THE INVENTION

A most preferred embodiment of the decalcomania transferring apparatus according to the invention includes a vacuum chamber provide to the outside of the decalcomania transferring tank for vacuum sucking residues of a decalcomania transferring film floating on the water surface in the decalcomania transferring tank and water in the tank through a pipe connected to a suction port for sucking the residues and water, and the vacuum chamber includes a residue discharging mechanism having a discharge port for discharging residues and water sucked in the chamber and a drain valve for opening and closing the discharge port.

Further, the residue discharging mechanism is adapted such that the drain valve is closed automatically by the suction force of the vacuum pump for evacuating the inside of the vacuum chamber and opened automatically when the suction force of the vacuum pump can no more resist the weight of the residues and water sucked in the vacuum chamber by the weight of them, and includes a control device to open the drain valve by lowering the suction force of the vacuum chamber thereby discharging the residues and water sucked in the vacuum chamber from the discharge port of the chamber when the residues and water sucked in the vacuum chamber reach a predetermined amount.

Further, the control device is adopted so as to judge whether the residues and water sucked in the vacuum chamber reach a predetermined amount or not based on a detection signal from a pressure gage for detecting the vacuum degree in the vacuum chamber or on a detection signal from a liquid level meter for detecting the water level in the vacuum chamber.

Further, the discharge port of the vacuum chamber which is opened or closed by the drain valve is situated below the water surface of an overflow tank for drawing the residues and water discharged from the discharged port and overflowing the residues together with surplus water to the outside of the tank.

Further, the decalcomania transferring apparatus includes a water supply device for supplying water to the inside of the decalcomania transferring tank such that the water level in the decalcomania transferring tank is not lowered when the residues of the decalcomania transferring film floating on the water surface in the decalcomania transferring tank is sucked together with water in the tank from the sucking port, a recovery tank for recovering surplus water overflown to the outside of the overflow vessel, a residue recovery device for separating and recovering the residues overflown to the outside of the overflow tank together with surplus water, and a water supply channel for supplying water discharged from the discharge port of the vacuum chamber to the overflow tank and recovered in the recovery tank to the water supply device.

### DESCRIPTION OF THE ACCOMPANYING DRAWINGS

FIG. 1 is a view showing an example of a decalcomania transferring apparatus according to the present invention; and

FIG. 2 is a view showing the operation of the residue discharging mechanism provided to the decalcomania transferring apparatus shown in FIG. 1.

### PREFERRED EMBODIMENT OF THE INVENTION

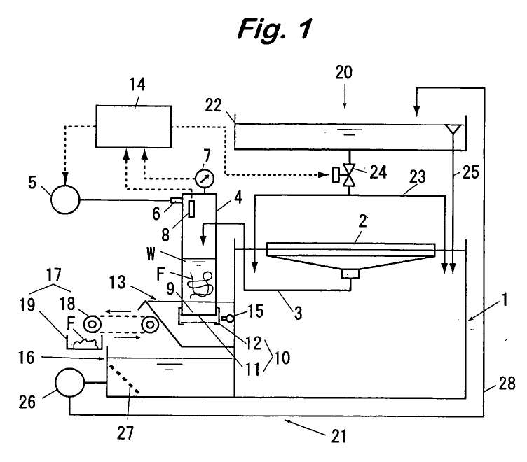

In a decalcomania transferring apparatus shown in FIG. 1, a decalcomania transferring tank 1 has a suction port 2 for sucking residues of a decalcomania transferring film floating on the water surface in the decalcomania transferring tank 1 together with water in the tank and a vacuum chamber 4 for vacuum-sucking the residues and water sucked from the suction port 2 through a siphon pipe 3 connected with the suction port 2 to the outside of the decalcomania transferring tank 1.

The vacuum chamber 4 being formed as a vertical cylindrical shape has, at the upper end thereof, an exhaustion port 6 for evacuating the inside of the chamber by a vacuum pump 5, and a pressure gage 7 for detecting the degree of vacuum in the chamber, and a liquid level meter 8 for detecting the water level in the chamber and has, at the lower end thereof, a discharge port 9 for discharging residues F of a decalcomania transferring film and water W sucked in the chamber, and a drain valve 10 for opening and closing the discharge port 9.

The drain valve 10 has a plate-shaped valve body 11 having a size capable of tightly closing the discharge port 9 and a guide frame 12 supporting the periphery of the valve body 11 vertically movably by a plurality of bars such that the valve body 11 is retractable relative to the discharge port 9. The drain valve 10 and the discharge port 9 are situated below the water surface of an overflow tank 13 for drawing the residues F and water W discharged from the discharge port 9 downward and overflow the residues together with surplus water to the outside of the tank. Thus, the drain valve 10 is adopted such that the valve body 11 is attracted together with water in the overflow tank 13 from the state shown by the dotted chain in FIG. 1 to a valve-closing state of closing the discharge port 9 as shown by a solid line in FIG. 1 to the discharge port 9 under the suction force of the vacuum pump 5 that evacuates the inside of the vacuum chamber 4. Further, in a case where the suction force of the vacuum pump 5 is lowered and when the suction force can no more resist the weight of the residues F and water W sucked in the vacuum chamber 4, and the valve body 11 is detached by the weight of them from the discharge port 9 and the valve body 11 is brought into an opened state of opening the discharge port 9 as shown in a dotted chain in FIG. 1. That is, the drain valve 10 is closed by the suction force of the vacuum pump 5 that evacuates the inside of the vacuum chamber 4 and opened when the suction force of the vacuum pump 5 can no more resist the weight of the residues F and water W sucked into the vacuum chamber 4.

As the vacuum pump 5, a Root's blower, for example, that can vary the amount of an exhaust from the discharge port 6 of the vacuum chamber 4 by the blower by controlling the rotational speed of an inverter motor driving the blower is used, and the vacuum pump 5 has a controller 14 that opens the drain valve 10 by decreasing the amount of the exhaust from the vacuum pump 5 to lower the suction force when the residues F and water W sucked in the vacuum chamber 4 by the suction force of the vacuum pump 5 reach a predetermined amount.

The control device 14 is adapted to output a control signal for controlling the suction force of the pump by controlling the amount of the exhaust of the blower by varying the number of rotation of the inverter motor that drives the blower of the vacuum pump 5 based on a detection signal from the pressure gage 7 for detecting the vacuum degree in the vacuum chamber 4. That is, when the amount of the residues F and water W sucked under vacuum in the vacuum chamber 4 increases, the pressure in the chamber 4 increases correspondingly and when the pressure gage 7 that detects the amount of the residues F and water W in the chamber depending on the pressure outputs a signal detecting that the amount reaches a predetermined amount, the control device 14 outputs a control signal based on the detection signal for decreasing the amount of the exhaust of the pump to lower the suction force from the control device 14 to the vacuum pump 5. Thus, the drain valve 10 opens automatically due to the weight of the residues F and water W sucked in the vacuum chamber 4 to open the discharge port 9 of the vacuum chamber 4 and the residues F and water W in the vacuum chamber 4 are drained downward through the discharge port 9 into the overflow tank 13.

The signal detecting that the residues F and water W in the vacuum chamber 4 reach the predetermined amount is outputted from the pressure gage 7 when the residues F and water W sucked under vacuum in the vacuum chamber 4 flow through the discharge port 6 and reach such a fully-charged state as not flown into the vacuum pump 5.

The liquid level gage 8 is disposed as a safety device for stopping the operation of the vacuum pump 5 when the residues F and water W sucked in the vacuum chamber 4 exceed a predetermined amount in order to prevent that the residues F and water W in the vacuum chamber 4 flow out of the discharge port 6 to cause failure to the vacuum pump 5. When the water level detected by the liquid level gage 8 exceeds a predetermined level, the controller 14 outputs a control signal to the vacuum pump 5 to stop the operation thereof. The liquid level gage 8 may be used instead of the pressure gage 7 for detecting whether the residues F and water W sucked in the vacuum chamber 4 reaches a predetermined amount or not to lower the suction force of the vacuum pump 5 by the detection signal.

The overflow tank 13 to which the residues F and water W are drained downward through the discharge port 9 of the vacuum chamber 4 has a nozzle 15 for wiping off the residues deposited to the valve body 11 or the guide frame 12 of the drain valve 10 and forming a water stream for causing the residues of overflow in the tank together with surplus water to the outside of the tank. Further, the decalcomania transferring apparatus shown in FIG. 1 has a recovery tank 16 for the recovery of surplus water overflown to the outside of the overflow tank 13 and a residue recovery device 17 for separating and recovering the residues overflown together with surplus water. The residue recovery device 17 has, for example, a net conveyer 18 for separating under filtration only the residues from surplus water overflown from the overflow tank 13 and drained downward into the recovery 16 and a store tank 19 for the residues recovered by filtration through the conveyer.

Further, the decalcomania transferring apparatus of this embodiment has a water supply device 20 for supplementing water into the decalcomania transferring tank 1 such that the water level in the decalcomania transferring tank 1 is not lowered upon sucking the residues of the decalcomania transferring film floating on the surface of the tank 1 together with water in the tank from the suction port 2. In order to effectively utilize water discharged from the discharge port 9 of the vacuum chamber 4 and recovered from the overflow tank 13 to the recovery tank 16, water in the recovery tank 16 is supplied through a water supply channel 21 to the water supply device 20.

In the water supply device 20, an automatic valve 24 that is controlled to on-off by the control device 14 is disposed to the water supply pipe line 23 for supplementing water from the inside of the water supply tank 22 that stores water supplied from the recovery tank 16 by way of the water supply channel 21 into the decalcomania transferring tank 1, so that the amount of water supplied can be controlled. An overflow pipe line 25 for overflowing the surplus water into the decalcomania transferring tank 1 is disposed to the water supply tank 22. Further, the water supply channel 21 has a water supply pump 26, a strainer 27 for filtering water in the recovery tank 16 supplied by the pump 26, and a water supply pipe line 28 for supplying water filtered through the strainer 27 to the water supply tank 22 of the water supply device 20 by the water supply pump 26.

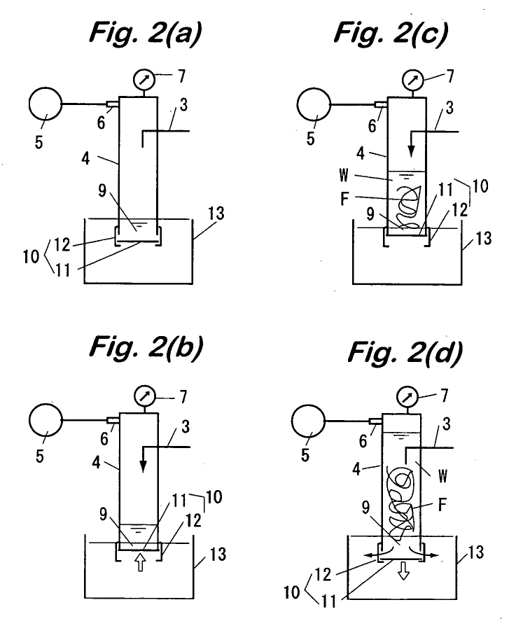

The entire constitution and the operation of the decalcomania transferring apparatus shown in FIG. 1 are as have been described above. The main operation of the residue discharging mechanism provided in the decalcomania transferring apparatus is to be described specifically with reference to FIG. 2.

In a state where a decalcomania transferring film has not yet been supplied to the water surface in the decalcomania transferring tank, the vacuum pump 5 is stopped or operated at a low speed, in which the drain valve 10 opens by its own weight to keep the discharge port 9 open in the vacuum chamber 4 open as shown in FIG. 2 (a).

In this state, when the decalcomania transferring film is supplied to the water surface in the decalcomania transferring tank and a work urged against the film downward is submerged in the tank, the vacuum pump 5 is instantly operated to evacuate the inside of the vacuum chamber 4. Then, the valve body 11 of the drain valve 10 is attracted together with water in the overflow tank 13 to the discharge port 9 of the vacuum chamber 4 to automatically close the drain valve 10. The discharge port 9 is closed by the drain valve 10 and, at the same time, the residues F of the decalcomania transferring film floating on the water surface in the decalcomania transferring tank and water W in the tank are sucked under vacuum through the siphon pipe 3 connected with the suction port 2 of FIG. 1 and sucked under vacuum into the vacuum chamber 4 as shown in Fig. (b).

Then, as shown in FIG. 2 (d), when the residues F and water W sucked in the vacuum chamber 4 reach such a predetermined amount as approximate to their limit but not flowing out of the discharge port 6, a control signal that decreases the exhaustion amount of the vacuum pump 5 to lower the suction force thereof is outputted from the control device 14 in FIG. 1 based on a detection signal of the pressure gage 7 that detects the amount depending on the vacuum degree in the vacuum chamber 4, the vacuum degree in the vacuum chamber is lowered and the drain valve 10 closes automatically by the weight of the residues F and water W sucked in the chamber, and the residues F and water W are drained downward into the discharge port 9 into the overflow tank 13 and the vacuum chamber 4 and the drain valve 10 return to the state shown in FIG. 2 (a). Accordingly, even when the vacuum chamber 4 is of a small size, the residues of the decalcomania transferring film of a large size can be sucked rapidly in a short time and discharged to the outside of the decalcomania transferring tank by repeating the operation shown in FIG. 2 (a) to (d).

The suction port in the invention is not restricted in view of the shape, the structure, and the place for installation so long as the suction port can suck the residues of the decalcomania transferring film floating on the water surface in the decalcomania transferring tank together with water in the tank. Further, the structure of the drain valve for opening and closing the discharge port of the vacuum chamber is not restricted only to that of this embodiment so long as it closes upon vacuum-suction of the residues of the decalcomania transferring film into the vacuum chamber and opens upon discharging the residues sucked in the chamber.

According to the invention, since the residues of the decalcomania transferring film floating on the water surface in the decalcomania transferring tank can be rapidly discharged to the outside of the decalcomania transferring tank to reliably prevent occurrence of seediness on the surface of the work even when the film comprises a water insoluble resin film or the size thereof is large, this can contribute to the improvement of the quality and the improvement of the productivity in the hydraulic decalcomania transfer.

The present disclosure relates to subject matter contained in priority Japanese Patent Application No. 2004-273,820 filed on Sep. 21, 2004, the contents of which is herein expressly incorporated by reference in its entirety.

What is claimed is:

1. A hydraulic decalcomania transferring apparatus having a residue discharging mechanism for discharging residues of a decalcomania transferring film floating on a water surface in a decalcomania transferring tank to the outside of the tank in which
a vacuum chamber for vacuum-sucking the residues of the decalcomania transferring film floating on the water surface in the decalcomania transferring tank together with water in the tank through a pipe connected with a suction port for sucking the residues together with water is provided and;
the vacuum chamber is provided with a discharge port for discharging the residues and water sucked in the chamber and a drain valve for opening and closing the discharge port.

2. A hydraulic decalcomania transferring apparatus according to claim 1, wherein a water supply device for supplying water to the decalcomania transferring tank is provided so that the water level in the decalcomania transferring tank is not lowered when the residues of the decalcomania transferring film floating on the water surface in the decalcomania transferring tank is sucked together with water in the tank from the suction port.

3. A hydraulic decalcomania transferring apparatus according to claim 2, wherein a water supply channel is formed for supplying water discharged from the discharge port to the water supply device.

4. A hydraulic decalcomania transferring apparatus according to claim 1, wherein the drain valve is opened by the suction force of a vacuum pump for evacuating the inside of the vacuum chamber and the drain valve opens when the suction force of the vacuum pump can no more resist the weight of the residues and water sucked in the vacuum chamber by the weight thereof.

5. A hydraulic decalcomania transferring apparatus according to claim 4, having a control device for lowering the suction force of the vacuum pump thereby opening the drain valve when the residues and water sucked in the vacuum chamber by the suction force of the vacuum pump reach a predetermined amount.

6. A hydraulic decalcomania transferring apparatus according to claim 4, wherein the discharge port which is opened or closed by the drain valve is situates below the water surface in the overflow tank that drains downward the residues and water discharged from the discharge port and overflows the residues together with surplus water to the outside of the tank.

7. A hydraulic decalcomania transferring apparatus according to claim 6, having a recovery tank for recovering surplus water overflown to the outside of the overflow tank and a residue recovery device for separating and recovering the residues overflown together with surplus water are provided.

8. A hydraulic decalcomania transferring apparatus according to claim 5, wherein the discharge port which is opened or closed by the drain valve is situates below the water surface in the overflow tank that drains downward the residues and water discharged from the discharge port and overflows the residues together with surplus water to the outside of the tank.

9. A hydraulic decalcomania transferring apparatus according to claim 8, having a recovery tank for recovering surplus water overflown to the outside of the overflow tank and a residue recovery device for separating and recovering the residues overflown together with surplus water are provided.

10. A residue discharging mechanism for discharging residues of a decalcomania transferring film floating on a water surface in a decalcomania transferring tank to the outside of the tank, in which
a vacuum chamber for sucking under vacuum the residues together with water in the decalcomania transferring tank has a discharge port for discharging the residues and water sucked in the chamber and a drain valve for opening and closing the discharge port, and
the drain valve is adapted to close by the suction force of the vacuum pump for evacuating the inside of the vacuum chamber and open when the suction force of the vacuum pump can no more resist the weight of the residues and water sucked in the vacuum chamber by the weight thereof.
